(19) United States
(12) Patent Application Publication
(10) Pub. No.: US 2012/0088087 A1
(43) Pub. Date: Apr. 12, 2012

(54) AMPHIPHILIC POLYCONDENSATION PRODUCTS AND USE IN COMBINATION WITH POLYESTER OR POLYESTER CONTAINING SURFACES

(75) Inventors: ALEXANDER LERCH, GELNHAUSEN (DE); MANFRED SCHADE, MULHOUSE (FR)

(73) Assignee: POLYPREC GMBH, GELNHAUSEN (DE)

(21) Appl. No.: 13/236,063

(22) Filed: Sep. 19, 2011

(30) Foreign Application Priority Data
Sep. 17, 2010 (DE) 10 2010 045 778.7

(51) Int. Cl. B32B 5/00; D21H 17/53; C08G 63/183

(52) U.S. Cl. 428/221; 528/298; 162/164.7

(57) ABSTRACT

The present invention relates to hydrophilically terminated amphiphilic polycondensates with a content of from 1 wt. % of copolymerized diol based on hydrogenated and doubly dehydrated aldo- and ketohexoses and use thereof in combination with polyester and polyester-containing surfaces.

It has long been known that polyester surfaces can be modified by suitable amphiphilic polymers, and that the surfaces are thereby semipermanently hydrophilized. This effect is already used commercially today in several applications.

In the detergents industry, such compounds are also referred to as soil release polymers. These are nonionic or anionic in nature, end-capped or also non-end-capped polycondensates being described in the relevant literature. Thus for example in U.S. Pat. No. 4,721,580 Gosselink describes anionically end-capped structures as soil release polymers and the use thereof in detergents and cleaning agents. Recent applications by Morschhaeuser et al. describe nonionic compounds in DE 102008023803A1 and anionic modifications in DE 102005 061058A1 as well as isolation thereof in DE 102008028409A1. For use in the textiles industry, amphiphilic polymers, e.g. Milease™ from ICI, have already long been known and are used in textile finishing for hydrophilization of polyester fibres and polyester blended fabrics. Thus for example in U.S. Pat. No. 3,416,952 McIntyre describes the coating of polyester fibres with hydrophilic polycondensates and wash trials for optimization of the wash resistance of finished textiles.

This technology finds a further application in the production of paper. Owing to the increasing use of recycled paper and the lower consumption of water, sticky impurities (stickies) in the waste paper are of particular significance. Stickies are essentially based on the various types of adhesives (letter closures, post-its, adhesive tape residues, etc.) which deposit onto machine parts, particularly in the recycling process, as a result of which the wet paper sieve acquires particular importance. Thus as early as 1989 in U.S. Pat. No. 5,209,823, Smith et al. described in the synthesis of nonionic open-chain polycondensates and in 1993 in U.S. Pat. No. 5,415,739 the use thereof as additives in the ppm range for the avoidance of adhesions on polyester surfaces, especially during the production of paper. Alternative technologies are for example described by Kohler et al. in EP 1268923 B1. In this, mixtures of polyvinyl alcohols and bentonite are used, high concentrations of 0.1-1% of polyvinyl alcohol being needed in order to obtain effects.

All previously described amphiphilic polycondensates are made up of conventional building blocks. Prominent here are aromatic and aliphatic dicarboxylic acids, which may also be sulphonated. Monocarboxylic acids, sulphonated and non-sulphonated, and primary alcohols, which can be sulphonated and/or alkoxylated, are used as end caps. Diols based on ethylene glycol, propylene glycol and polyalkylene glycols are described as diol components. Triols and polyhydric alcohols such as for example glycerine, pentaerythritol, sorbitol and compounds derived therefrom are used as crosslinking components. Polyfunctional crosslinkers, which contain both alcohol functions and also acid functions, such as for example citric acid or also tartaric acid are described in the relevant patent literature, see for example Morschhäuser et al. in DE 102008023803A1.

Owing to the rising price of crude oil, alternative raw materials have attracted attention in the last few years. From standard works it is known to those skilled in the art that hexyls are accessible from aldo- and ketohexoses, such as for example glucose, galactose, mannose, etc., by hydrogenation, such as for example sorbitol from glucose or mannitol from mannose. Further, it is known that diols can be obtained from these products by double dehydration. Thus for example isosorbide (CAS No. 652-67-5), also called 1,4-3,6-di-anhydrosorbitol, which is commercially available (Roquette, France) is formed from sorbitol. Isosorbide is described in many patents as a glycolic component for modifying the characteristics of mouldable articles. In U.S. Pat. No. 6,656,577, Adelmann describes isosorbide as a glycolic component for the production of standard hydrophobic polyester condensates and the use thereof as starting material for the production of bottles, films and fibres.

Until now, there has been only little detailed mention of isosorbide-containing amphiphilic systems. Thus for example in WO 2010/017651 Nageli et al. describe the synthesis of hydrophilic polyesters, wherein the hydrophilic polymers are capped with hydrophobic end groups in a subsequent reaction step. The surface-active compounds are claimed for use in for example cleaning agents but above all as PEG-free emulsifiers for cosmetic formulations.

Sulphonated non-end group-capped isosorbide-containing structures are claimed by Hayes et al. in U.S. Pat. No. 6,368,710 for the purpose of producing fibres, films or other shaped articles with improved biological degradability.

Previously unknown is the use of diols based on hydrogenated and doubly dehydrated aldohexoses, such as for example isosorbide, for the already described use fields of the amphiphilic polycondensates as textile additives, soil release polymers or as additives for the production of paper.

It has now surprisingly been found that nonionic isosorbide-containing polycondensates which are capped with hydrophilic alkylalkoxylate end groups, as well as improved primary wash performance, also display an improved soil release action compared to the state of the art.

A subject of the invention is hydrophilically terminated isosorbide-containing polycondensates which contain units derived from dicarboxylic acids and/or derivatives thereof, from other diols and/or from polyols, characterized in that the content of isosorbide is at least 1%.

A further preferred embodiment is the synthesis of hydrophilically terminated isosorbide-containing polycondensates which contain structural elements,
a) which are derived from di- and/or polycarboxylic acids and/or derivatives thereof, selected from:
   aromatic di- and/or polycarboxylic acids and/or salts thereof and/or anhydrides thereof and/or esters thereof,
   aliphatic and cycloaliphatic dicarboxylic acids, salts thereof, anhydrides thereof and/or esters thereof,
   sulpho group-containing dicarboxylic acids, salts thereof, anhydrides thereof and/or esters thereof and
b) which are derived from isosorbide and further diols and
c) oxalkylated C1-C24 alcohols and
d) optionally polyols, which are derived from
e) sulpho group-containing acids, optionally
f) from sulpho group-containing alcohols, optionally
g) from diol ethers or polyol ethers, optionally.

A further preferred embodiment is the synthesis of hydrophilically terminated isosorbide-containing polycondensates, characterized in that dicarboxyl compounds are used which are derived from: terephthalic acid, phthalic acid, isophthalic acid, naphthalenedicarboxylic acid, anthracenedicarboxylic acid, biphenyldicarboxylic acid, terephthalic anhydride, phthalic anhydride, isophthalic anhydride, mono and dialkyl esters of terephthalic acid, phthalic acid and isophthalic acid with C1-C6 alcohols, preferably dimethyl terephthalate, diethyl terephthalate and di-n-propyl terephthalate, polyethylene terephthalate, polypropylene terephthalate, oxalic acid, succinic acid, glutaric acid, adipic acid, fumaric acid, maleic acid, itaconic acid, pimelic acid, suberic acid, azelaic acid, sebacic acid and anhydrides thereof, and the mono and dialkyl esters of the carboxylic acids with C1-C6 alcohols, e.g. diethyl oxalate, diethyl succinate, diethyl glutarate, methyl adipate, diethyl adipate, di-n-butyl adipate, ethyl fumarate and dimethyl maleate, 5-sulphoisophthalic acid or alkali or alkaline earth metal salts thereof, in particular lithium or sodium salts or mono-, di-, tri- or tetraalkylammonium salts with C1 to C22 alkyl residues, mono and dialkyl esters of 5-sulphoisophthalic acid, 2-naphthyl dicarboxybenzoylsulphonate, 2-naphthyl dicarboxybenzene-sulphonate, phenyl dicarboxybenzenesulphonate, 2,6-dimethylphenyl 3,5-benzenesulphonate or phenyl 3,5-dicarboxybenzenesulphonate.

A further preferred embodiment is the synthesis of hydrophilically terminated isosorbide-containing polycondensates, characterized in that dicarboxylic acids are used which are derived from terephthalic acid and/or dialkyl terephthalate, in particular dimethyl terephthalate.

A further preferred embodiment is the synthesis of hydrophilically terminated isosorbide-containing polycondensates, characterized in that sulpho group-containing dicarboxylic acids and/or salts thereof, anhydrides thereof and/or esters thereof are used, for example 5-sulphoisophthalic acid or alkali or alkaline earth metal salts thereof, in particular lithium or sodium salts or mono-, di-, tri- or tetraalkylammonium salts with C1 to C22 alkyl residues, 2-naphthyl dicarboxybenzoylsulphonate, 2-naphthyl dicarboxy-benzenesulphonate, phenyl dicarboxybenzenesulphonate, 2,6-dimethylphenyl 3,5-benzenesulphonate or phenyl 3,5-dicarboxybenzenesulphonate.

A further preferred embodiment is the synthesis of hydrophilically terminated isosorbide-containing polycondensates, characterized in that end groups are used, the end groups being derived from a compound according to the formula (R3O(CHR1CHR2O)nH) wherein R1 and R2 independently of each other stand for hydrogen or for an alkyl group with 1 to 4 carbon atoms, preferably for hydrogen and/or methyl, R3 stands for an alkyl group with 1 to 4 carbon atoms and n is a number in the range from 1 to 50, preferably 10 to 30, particularly preferably 15 to 25.

A further preferred embodiment is the synthesis of hydrophilically terminated isosorbide-containing polycondensates, characterized in that in addition to isosorbide, glycol building blocks are used which contain structural elements which are derived from: ethylene glycol, 1,2-propylene glycol and/or 1,2-butylene glycol.

A further preferred embodiment is the synthesis of hydrophilically terminated isosorbide-containing polycondensates, characterized in that polyalkylene building blocks are used which are derived from: polyethylene glycols and/or polypropylene glycols with molecular weights of 200 to 7000, preferably 3000 to 6000 g/mol, polymerization products from propylene glycol, ethylene glycol and/or butylene glycol in blocks, gradientwise or also in random distribution with molecular weights of 90 to 7000, preferably of 200 to 5000.

A further preferred embodiment is the synthesis of hydrophilically terminated isosorbide-containing polycondensates, characterized in that crosslinking polyglycols are used which contain structural units which are derived from: polyols, in particular glycerine, pentaerythritol, trimethylolethane, trimethylolpropane, 1,2,3-hexanetriol, sorbitol or mannitol.

A further preferred embodiment is the synthesis of hydrophilically terminated isosorbide-containing polycondensates, characterized in that end groups are used which are derived from: oxalkylated (alkoxylated) C1-C22 alcohols, in particular methanol, ethanol, octyl alcohol, decyl alcohol, lauryl alcohol, myristyl alcohol or stearyl alcohol, and the corresponding oxalkylated (alkoxylated), in particular ethoxylated and/or propoxylated alcohols, alkylphenols, in particular methanol, ethanol, octyl-phenol, nonylphenol and dodecylphenol and oxalkylated (alkoxylated) C6-C18 alkylphenols, and/or alkylamines, in particular C8-C24 monoalkylamines and/or oxalkylated (alkoxylated) C8-C24 alkylamines.

A further preferred embodiment is the synthesis of hydrophilically terminated isosorbide-containing polycondensates containing ionic end caps which are derived from sulpho group-containing acids, preferably from 2-hydroxyethanesulphonic acid and sulphobenzoic acid.

A further preferred embodiment is the synthesis of hydrophilically terminated isosorbide-containing polycondensates, characterized in that end groups are used, the end groups being derived from a compound according to the formula (XO3S(CHR1CHR2O)nH), wherein R1 and R2 independently of each other stand for hydrogen or for an alkyl group with 1 to 4 carbon atoms, preferably for hydrogen and/or methyl, X stands for Li, Na, K, Ca or Mg and n is a number in the range from 1 to 50, preferably 2 to 10.

A particularly preferred embodiment is the synthesis of hydrophilically terminated isosorbide-containing polycondensates, characterized in that components are used for the synthesis which are derived from:
a) one or more nonionic aromatic dicarboxylic acids or C1-C4 alkyl esters thereof,
b) 1,2-propylene glycol,
c) C1-C8 alkyl polyalkylene glycol ethers with an average molecular weight of the polyalkylene glycol ether of 200 to 5000 and
d) isosorbide.

On the basis of U.S. Pat. No. 4,702,857, nonionic capped polycondensates based on 1,2-propanediol were now prepared and the 1,2-propanediol gradually exchanged for isosorbide. The ratio of end group and dicarboxylic acid was varied in order to optimize the solubility of the compound. As the catalyst system, instead of the toxic antimony trioxide of the catalyst system known in the literature, titanium tetraisopropylate/sodium acetate was used (see DE 19826356A1).

### EXAMPLES

29.58 g of dimethyl terephthalate, 34.78 g of 1,2-propanediol, isosorbide (see examples for quantities), 98 mg of anhydrous sodium acetate and 53 μL of Ti(OiPr)₄ are placed in a 250 mL three-necked flask fitted with magnetic stirrer, column, distillation head, internal thermometer and gas inlet tube. The reaction mixture is blanketed with N₂ and then heated to 200° C. Within 90 minutes, ca. 9 mL of methanol are distilled off. After the slightly yellow viscous mass has cooled to 80° C., 82 g of MPG750 are added to this. The mixture is heated to ca. 200-220° C. by means of a heating mantle, and the pressure is reduced to 1-2 mbar. Distillation sets in at an internal temperature of ca. 130-226° C. and 51-94° C. head temperature. The reaction solution discolours somewhat during the condensation phase. The distillation is ended after ca. 2.5 hours, varying quantities of distillate being obtained depending on the quantity of glycol used. The reaction product is isolated as the active substance in solid to viscous liquid form.

Analogously to Example 1, the polyesters 4 and 5 according to the invention can also be prepared with the following starting materials:

### Example 2

29.58 g dimethyl terephthalate
34.8 g 1,2-propanediol
114.3 g methylpolyethylene glycol 750
0.098 g sodium acetate
53 μL titanium tetraisopropylate

### Example 3

29.58 g dimethyl terephthalate
34.8 g 1,2-propanediol
101 g methylpolyethylene glycol 750
0.098 g sodium acetate
53 μL titanium tetraisopropylate

### Example 4

29.58 g dimethyl terephthalate
33.6 g 1,2-propanediol
101 g methylpolyethylene glycol 750
2.2 g isosorbide
0.098 g sodium acetate
53 μL titanium tetraisopropylate

### Example 5

29.58 g dimethyl terephthalate
25.5 g 1,2-propanediol
101 g methylpolyethylene glycol 750
17.8 g isosorbide
0.098 g sodium acetate
53 μL titanium tetraisopropylate

The content of the isosorbide part structure was determined by 13C NMR spectroscopy. A DEPT spectrum displays the characteristic 13C signals of the bridgehead atoms. Further, in solution the polycondensates obtained rotate the angle of polarized light, so that the optical activity can be used as a simple means for in-line content determination.

It was now surprisingly found that hydrophilically terminated amphiphilic isosorbide-containing polycondensates are accessible which display a markedly improved soil removal action compared to the state of the art. Evidently the tetrahydrofuran-like part structures have an additional influence on the cleaning performance of the polycondensates.

Wash trials were now performed with the polycondensates prepared in this way. As the base in each, 75 ml of Spee colour liquid (Henkel, UN 04167458) was used, at a hardness degree of 26° dt hardness. The wash trials were performed in a Sensation 9516 washing machine from the firm Privileg, with a standard loading of 3 kg towelling—cotton fabric, however any other normal commercial washing machine can be used. As the program, the 30 min short program at 30° C. was selected. As test fabric, a decorative hanging (ready-made curtain, Bettenwelt GmbH & Co KG, D24976 Handewitt) was cut into 5 cm×5 cm sized squares.

The main procedure takes the form of a prewash with the polymer to be studied, a deliberate soiling with one drop of used engine oil and then a simple wash (short program 30 mins). The results are repeated at least three times, and the values stated correspond to the respective mean values.

Each time, the samples are dried, scanned in with a normal commercial scanner (Epson SX 100, 300 dpi) and the brightness of the jpg images obtained studied with a normal commercial image assessment program (e.g. Gimp2). In the testing of the polymer samples, 0.5 g of polymer substance (100%) was added each time to the prewashes and the subsequent washes. As the commercial reference substance, Marloquest™ L 235 M (Sasol) was used. The brightness value obtained in each case in % compared to the singly pretreated fabric is plotted (FIG. 1).

The good cleaning performance of the isosorbide-containing polycondensates according to Examples 4 and 5 is surprising. Thus these are superior to the state of the art Marloquest L 235M.

A further important property of the polymers is their primary wash performance. To investigate this property, polyester fabric is prewashed as already described without the addition of polymer, and the surface is treated with one drop of used oil, dried and now washed several times in the presence of a polymer. The quantities used and the wash conditions used are the same as those in the soil release test described above. The following graph (FIG. 2) shows the primary wash performance of the samples tested against a null sample (without additive) and the state of the art with Marloquest L 235 M after the second and third wash.

In this case also, the samples from Example 4 and Example 5 display a primary wash performance superior to the state of the art.

On the basis of U.S. Pat. No. 5,415,739, for simulation of the tendency to adhesion, tear tests were performed. For this, onto the unsoiled reference samples from the previous wash trials, normal commercial adhesive film (Tesa, width 1.5 cm, clear transparent) was glued onto the fibre surface and loaded for 20 mins with a weight weighing 100 g. After completion of this time, the force to remove the adhesive tape from the textile was determined. The detachment angle is ca. 180° and the speed 1 mm/sec. In each case, the highest tensile force determined during the test is stated.

| | Tensile | Std |
|---|---|---|
| | force [g/cm] | Deviation |
| Standard fabric | 28.7 | 2.2 |
| Polymer A US 5209823 | 22.3 | 1.5 |
| Marloquest L 235 M | 19.5 | 0.6 |
| Example 4 | 16.3 | 2.0 |

As can easily be seen from the table, the isosorbide-containing product according to Example 4 displays a markedly decreased tendency to the formation of adhesions to a standard adhesive tape.

### BRIEF DESCRIPTION OF THE DRAWINGS

The invention may take physical form in certain parts and arrangement of parts, embodiment of which will be described in detail in this specification and illustrated in the accompanying drawings which form a part hereof and wherein:

FIG. 1 is a graph that shows the brightness value obtained in each case in % compared to the singly pretreated fabric is plotted; and

FIG. 2 is a graph that shows the primary wash performance of the samples tested against a null sample (without additive) and the state of the art with Marloquest L 235 M after the second and third wash.

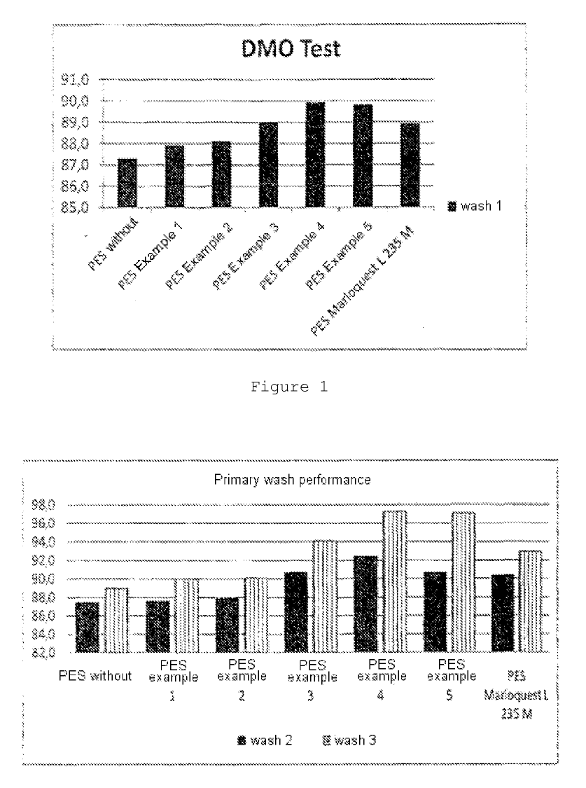

1. A hydrophilically terminated amphiphilic polycondensate comprising:
at least 1 wt. % of copolymerized diol based on hydrogenated and doubly dehydrated aldo- and ketohexoses, wherein the polycondensate is capable of being applied to polyester and polyester-containing surfaces.

2. The hydrophilically terminated amphiphilic polycondensate according to claim 1, wherein the condensate is of a nonionic or anionic nature.

3. The condensate according to claim 1 wherein the diol is isosorbide.

4. The polycondensate according to claim 1, wherein the polycondensate is adapted to be used as an additive in at least one of the group comprising detergents, cleaning agents, production of paper for the avoidance of residues on plant components during paper production, and coating textiles.

5. The polycondensate according to claim 2, wherein the polycondensate is adapted to be used as an additive in at least one of the group comprising detergents, cleaning agents, the production of paper for the avoidance of residues on plant components during paper production, and coating textiles.

6. The polycondensate according to claim 3, wherein the polycondensate is adapted to be used as an additive in at least one of the group comprising detergents, cleaning agents, the production of paper for the avoidance of residues on plant components during paper production, and coating of textiles.

7. A detergent comprising:
A hydrophilically terminated amphiphilic polycondesate comprising at least 1 wt. % of copolymerized diol based on hydrogenated and doubly dehydrated aldo- and ketohexoses in combination with polyester and polyester-containing surfaces.

8. A textile or cellulose-based product comprising:
A hydrophilically terminated amphiphilic polycondesate comprising at least 1 wt. % of copolymerized diol based on hydrogenated and doubly dehydrated aldo- and ketohexoses in combination with polyester and polyester-containing surfaces.

9. (canceled)

10. The condensate according to claim 2 wherein the diol is isosorbide.

11. The detergent according to claim 7, wherein the condensate is of a nonionic or anionic nature.

12. The detergent according to claim 7 wherein the diol is isosorbide.

13. The detergent according to claim 11 wherein the diol is isosorbide.

14. The textile according to claim 8, wherein the condensate is of a nonionic or anionic nature.

15. The textile according to claim 8 wherein the diol is isosorbide.

16. The textile according to claim 14 wherein the diol is isosorbide.

17. The cellulose-based product according to claim 8, wherein the condensate is of a nonionic or anionic nature.

18. The cellulose-based product according to claim 8 wherein the diol is isosorbide.

19. The cellulose-based product according to claim 18 wherein the diol is isosorbide.
